(19) United States
(12) Patent Application Publication
(10) Pub. No.: US 2026/0277725 A1
(43) Pub. Date: Sep. 17, 2026

(54) Machine Learning-Based Soft Error Resilience Enhancement System

(71) Applicants: Kee Sup Kim, El Dorado Hills, CA (US); Younggwang Jung, Incheon (KR); Eun Taek Oh, Seoul (KR); Jiwoo Nam, Seoul (KR); Yeong Bin You, Seongnam (KR)

(72) Inventors: Kee Sup Kim, El Dorado Hills, CA (US); Younggwang Jung, Incheon (KR); Eun Taek Oh, Seoul (KR); Jiwoo Nam, Seoul (KR); Yeong Bin You, Seongnam (KR)

(73) Assignee: Axion Co. Ltd., Seongnam (KR)

(21) Appl. No.: 19/081,081

(22) Filed: Mar. 17, 2025

Related U.S. Application Data
(60) Provisional application No. 63/566,307, filed on Mar. 17, 2024.

(51) Int. Cl. G06F 11/07

(52) U.S. Cl. CPC G06F 11/079; G06F 11/0736

(57) ABSTRACT

The present invention relates to a Resilience Enhancement Design System that detects and analyzes soft errors across multiple layers to optimize resilience techniques. The system includes a RESA Engine for error detection and analysis and an ML-Based Explorator that leverages machine learning to find optimal resilience enhancement techniques. The RESA Engine injects soft errors (e.g., SEU, SEMU), analyzes error patterns, and evaluates resilience techniques. The ML-Based Explorator explores resilience techniques across Circuit, Logic, Architecture, Software, and Algorithm layers, balancing cost (power, performance) and resilience improvement to find the best combination. Unlike conventional single-layer approaches, this invention enables multi-layer exploration, reducing exploration costs while ensuring high reliability in diverse environments.

### RELATED APPLICATIONS

This application claims the benefit of U.S. Provisional Patent Application No. 63/566,307, filed on Mar. 17, 2024.

This invention further develops the Enhanced Cross-Layer Protection for electronic circuits described in the provisional application by integrating an advanced ML-Based Explorator for automated resilience optimization, enabling efficient soft error mitigation, and reducing computational overhead associated with large-scale resilience analysis.

### FIELD OF THE INVENTION

The present invention relates to a Resilience Enhancement Design System that detects, analyzes, and recovers soft errors occurring in digital systems to improve reliability. More specifically, it pertains to a system that analyzes the impact of soft errors across multiple layers (Cross-Layer) rather than a single layer and utilizes machine learning to automatically explore the optimal resilience enhancement technique combinations. The invention includes technology for optimizing error detection and resilience at various layers such as Circuit, Logic, Architecture, Software, and Algorithm to minimize the increasing impact of soft errors due to semiconductor process miniaturization. It can be applied to the design of Resilience Architectures to ensure reliability in high-dependability environments such as data centers, aerospace, autonomous driving systems, and edge computing.

### BACKGROUND OF THE INVENTION

With increasing semiconductor integration and transistor miniaturization, digital systems have become more sensitive to environmental changes, making soft errors and resilience critical design factors. A soft error is a temporary data error caused by external factors such as radiation particle collisions, voltage fluctuations, and temperature changes, which may not immediately affect system operation but can lead to data corruption and computational errors, ultimately degrading system reliability.

Soft errors can cause the following issues depending on whether they are detected and corrected. Silent Data Corruption (SDC) occurs when an error is not detected, leading the system to continue using or storing incorrect data, potentially causing catastrophic failures in applications requiring high reliability, such as financial systems, medical data, and autonomous vehicles. Detected but Uncorrected Error (DUE) refers to cases where an error is detected but not automatically corrected, potentially resulting in system crashes or performance degradation.

To address these issues, resilience design has been developed, ensuring that systems maintain normal operation even in the presence of errors. Resilience includes detection (identifying errors), correction (fixing detected errors), and recovery (restoring the system to a normal state after errors occur). However, achieving high resilience often requires repeating computations, storing redundant data, and comparing results to detect and correct errors, leading to additional computation overhead, increased energy consumption, and longer execution times. Therefore, it is essential to analyze the trade-off between overhead and reliability to achieve optimal resilience.

Resilience Enhancement Techniques can be applied independently at various layers such as Circuit, Logic, Architecture, Software, and Algorithm. Recently, Cross-Layer Exploration has been introduced, allowing resilience enhancement techniques to be experimentally analyzed and optimized by combining resilience enhancement techniques at least one layer to find the best combination. This approach effectively mitigates soft errors at each layer, minimizes overhead, and maximizes reliability.

However, conventional Cross-Layer Exploration methods have limitations. Each layer has at least one resilience technique, and when combined, the number of possible combinations becomes vast. Experimentally analyzing all combinations requires enormous computational resources, hardware capacity, and time. Furthermore, an optimal combination derived in a specific experimental environment may not be directly applicable to new applications. In other words, the search for an optimal combination through Cross-Layer Exploration often demands impractically high computational costs, and conventional methods struggle to generalize the best solution across different environments.

To address these challenges, the present invention provides a Resilience Enhancement Design System that includes a Resilience Evaluation through Sensing and Analysis (RESA) Engine and an ML-Based Explorator, enabling automated exploration of optimal Resilience Enhancement Techniques across various layers. This system is designed to reduce exploration costs compared to conventional methods and quickly identify the best resilience combination even in new environments.

### SUMMARY OF THE INVENTION

The present invention relates to a Resilience Enhancement Design System that utilizes Machine Learning (ML) to automatically explore and apply optimal resilience enhancement techniques across multiple layers.

The conventional Cross-Layer Exploration approach enhances resilience by experimentally analyzing and combining applicable techniques across various layers such as Circuit, Logic, Architecture, Software, and Algorithm. However, due to the vast number of possible combinations, the exploration cost is extremely high, and generalizing the optimal combination for new application environments is challenging.

To overcome these issues, the present invention provides a Resilience Enhancement Design System comprising a RESA Engine and an ML-Based Explorator.
The RESA Engine injects artificial errors and analyzes the resulting error data to evaluate system resilience.
The ML-Based Explorator utilizes ML to explore resilience enhancement techniques and drastically reduce the number of combinations that need to be tested, automatically determining the optimal combination.

The present invention employs ML optimization techniques such as Reinforcement Learning and Bayesian Inference to derive the best resilience combination with significantly fewer experiments than conventional Cross-Layer Exploration methods. This allows for cost-effective exploration while maintaining high reliability, ensuring that the optimal resilience combination can be quickly identified and efficiently applied across various environments.

### BRIEF DESCRIPTION OF THE DRAWINGS

FIG. 1. Resilience Enhancement Design System

FIG. 1 is a block diagram illustrating the main components of the resilience enhancement design system according to an embodiment of the present invention.

FIG. 2. RESA Engine

FIG. 2 is a diagram illustrating the operation of the RESA engine according to an embodiment of the present invention.

FIG. 3. Error Injection Module

FIG. 3 is a diagram illustrating the operation of the error injection module according to an embodiment of the present invention.

FIG. 4. Error Detection and Analysis Module

FIG. 4 is a diagram illustrating the operation of the error detection and analysis module according to an embodiment of the present invention.

FIG. 5. Resilience Evaluation Module

FIG. 5 is a diagram illustrating the operation of the resilience evaluation module according to an embodiment of the present invention.

FIG. 5. ML-based Explorator

FIG. 6 is a diagram illustrating the operation of the ML-based explorator according to an embodiment of the present invention.

### DETAILED DESCRIPTION OF THE INVENTION

### Overview

With advancements in semiconductor and embedded systems, reliability and resilience have become essential design factors. In particular, as semiconductor manufacturing processes have scaled down to the nanometer (nm) level, reliability issues such as soft errors have become more frequent. Soft errors are primarily caused by external environmental factors such as radiation, electromagnetic interference (EMI), and temperature fluctuations, leading to system malfunctions and data errors, including Silent Data Corruption (SDC). Traditional resilience enhancement techniques are mostly static methods that apply predefined protection mechanisms. However, static techniques that are not optimized for specific applications and hardware environments may result in unnecessary power consumption and performance degradation and have limitations in responding optimally to real-time environmental changes.

To address these issues, the present invention proposes a Resilience Enhancement Design System that evaluates system reliability through error detection and analysis and leverages machine learning to automatically explore and apply the optimal resilience enhancement techniques. This approach allows the system to maximize reliability while minimizing performance degradation and power consumption.

Conventional resilience enhancement methods have inherent limitations due to their static protection mechanism approach. These existing techniques apply predefined error recovery methods, which are not optimized for specific environments, potentially leading to performance degradation and excessive power consumption. Additionally, they lack real-time optimization capabilities, making it difficult to automatically explore and combine the best resilience enhancement techniques in dynamically changing system environments. Furthermore, traditional systems struggle to quantitatively analyze the effectiveness of resilience techniques, making it challenging to accurately measure reliability improvements achieved through the applied techniques.

The present invention overcomes these limitations by incorporating a RESA Engine and an ML-Based Explorator, enabling real-time exploration and application of the optimal resilience enhancement techniques.

The Resilience Enhancement Design System of the present invention consists of two main components: the RESA Engine and the ML-Based Explorator. The RESA Engine experimentally evaluates system resilience by artificially injecting errors, performs error detection and analysis to quantitatively assess system reliability, and evaluates the effectiveness of resilience enhancement techniques based on detected error data. The ML-Based Explorator explores various resilience enhancement techniques and determines the optimal combination, utilizing machine learning techniques such as Reinforcement Learning, Bayesian Optimization, and Genetic Algorithms to perform optimization. Additionally, it is designed to continuously adapt to changes in the system environment, ensuring that the best resilience enhancement techniques are applied dynamically.

Through this approach, the present invention enables the automatic selection and application of resilience enhancement techniques optimized for different system environments, unlike conventional static approaches. Furthermore, based on the results of error detection and analysis, the system can quantitatively evaluate the effectiveness of reliability improvements achieved through applied resilience techniques.

### System Configuration

The Resilience Enhancement Design System of the present invention receives RTL (Register Transfer Level) data as input, artificially injects, detects, and analyzes errors, and then explores and applies the optimal resilience enhancement techniques. The system is primarily composed of two main components: the RESA Engine and the ML-Based Explorator. The RESA Engine performs error detection and analysis, while the ML-Based Explorator explores various resilience enhancement techniques and determines the optimal combination.

### Key Components of the System

FIG. 1 illustrates the Resilience Enhancement Design System according to one embodiment of the present invention. The system (100) consists of two main components: the RESA Engine (110) and the ML-Based Explorator (120). It processes RTL data as input and performs the resilience enhancement process.
RESA Engine (110) experimentally evaluates, detects, and analyzes errors occurring within the system. Specifically, it artificially injects errors to simulate soft errors that the system may encounter in real environments and analyzes the system's response to these errors. The results of this analysis are used to quantitatively evaluate how resilience enhancement techniques impact system reliability.
ML-Based Explorator (120) utilizes machine learning to explore and apply the optimal resilience enhancement technique combinations. Various resilience enhancement techniques exist, but their impact on system performance and power consumption varies depending on the environment. Therefore, this module employs optimization techniques such as Reinforcement Learning, Bayesian Optimization, and Genetic Algorithms to automatically search for and apply the best resilience enhancement combination. This enables adaptation to changing system environments while maintaining optimal reliability assurance techniques.

Unlike conventional static resilience enhancement methods, the Resilience Enhancement Design System of the present invention can dynamically search for and apply resilience enhancement techniques optimized for each system environment in real time. By detecting and analyzing errors through the RESA Engine and applying optimal resilience enhancement techniques using the ML-Based Explorator, the system maximizes reliability while minimizing costs associated with increased power consumption and performance degradation.

### Operation of the RESA Engine

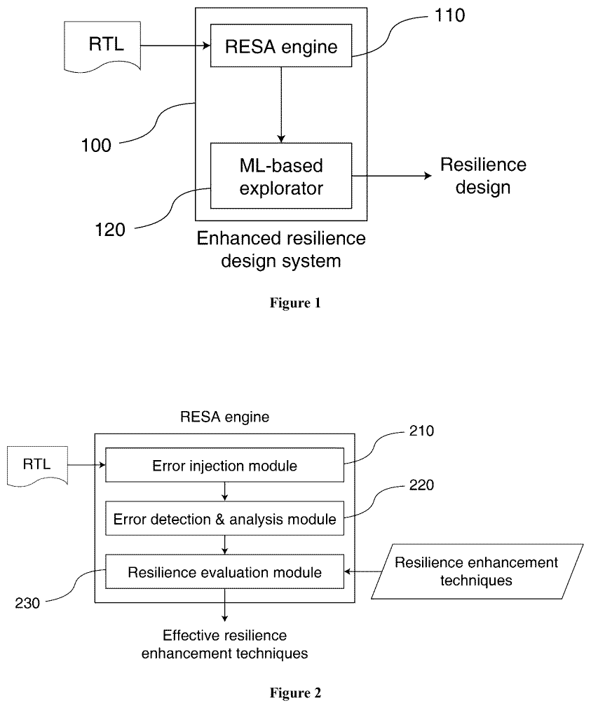

The RESA Engine of the present invention is a core module that performs error injection, detection, and analysis to evaluate system reliability. FIG. 2 illustrates the operation of the RESA Engine according to one embodiment of the present invention. The main components include the Error Injection Module, Error Detection and Analysis Module, and Resilience Evaluation Module. The RESA Engine detects and analyzes errors based on RTL data and quantitatively evaluates the effectiveness of resilience enhancement techniques.

### Error Injection Module

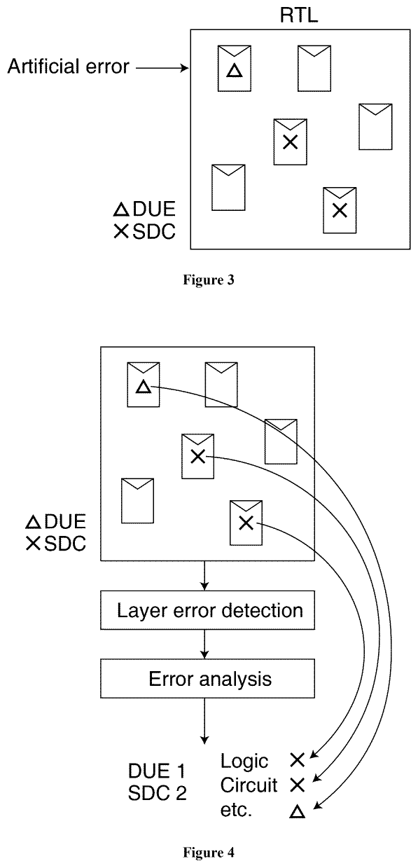

FIG. 3 illustrates the operation of the Error Injection Module according to one embodiment of the present invention. This module artificially injects soft errors into the system to experimentally reproduce error scenarios that may occur in real environments. Soft errors are primarily caused by external factors such as radiation, electromagnetic interference, and temperature fluctuations, potentially leading to system malfunctions.

The Error Injection Module introduces Single Event Upset (SEU) and Single Event Multiple Upset (SEMU), which are common types of soft errors. SEU refers to a single-event error that affects one bit or one memory cell, while SEMU involves multiple bits being altered simultaneously due to a single event. These soft errors significantly impact the reliability of real-time systems. The present invention includes experimental error injection and analysis to assess their effects.

Error injection can be applied to one or more processing units such as Processor Cores, Memory Units, and Accelerators, allowing the evaluation of how vulnerable each unit is to soft errors. Once errors are injected, error data from various layers-including circuits, logic, architecture, software, and algorithms-are collected for subsequent detection and analysis. This process is crucial in assessing system resilience before and after applying resilience enhancement techniques.

### Error Detection and Analysis Module

FIG. 4 illustrates the operation of the Error Detection and Analysis Module according to one embodiment of the present invention. This module analyzes the impact of injected soft errors on the system and categorizes the detected errors.

The error analysis process evaluates whether an error has been detected and its impact on system operation. The detected errors are classified into two major categories:
Silent Data Corruption (SDC): This occurs when the system fails to detect an error and continues processing corrupted data. Although the system appears to function normally, internal data may be compromised, leading to potential catastrophic failures.
Detected but Uncorrected Error (DUE): This refers to errors that the system detects but cannot automatically correct. Such errors can cause system crashes or performance degradation.

The Error Detection and Analysis Module analyzes detected errors across different layers. This enables an assessment of how well specific resilience enhancement techniques improve error detection and recovery performance, providing essential data for machine learning-based optimization in later stages.

Additionally, this module analyzes the occurrence frequency of SDC and DUE to determine which processing units are most vulnerable to errors. This allows for targeted improvements in error detection and correction techniques at specific layers. Compared to conventional error detection methods, the present invention performs multi-layered analysis and learns error patterns at each layer, providing essential data for optimizing resilience enhancement techniques in future applications.

### Resilience Evaluation Module

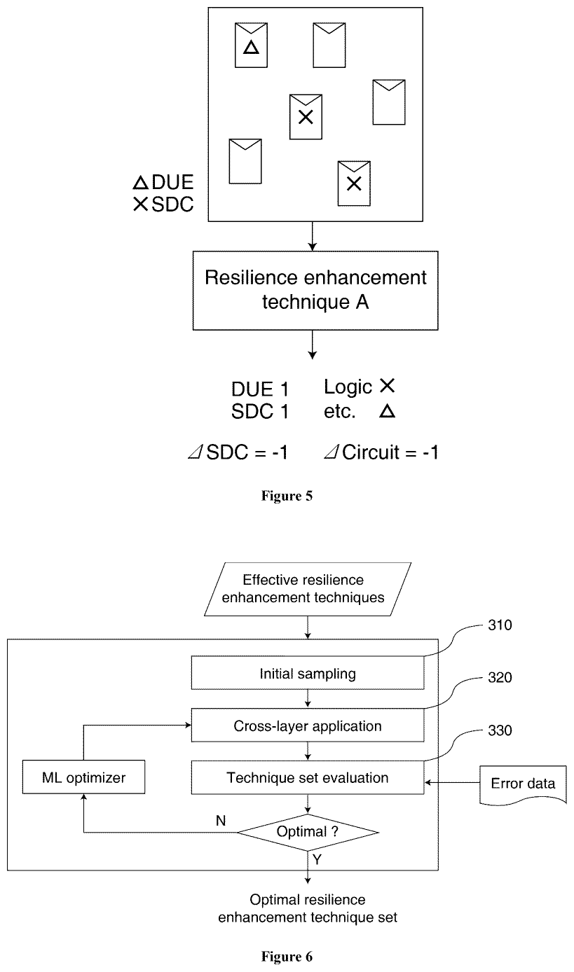

FIG. 5 illustrates the operation of the Resilience Evaluation Module according to one embodiment of the present invention. This module quantitatively evaluates system reliability improvements by measuring error detection and recovery rates and analyzing system performance changes after applying resilience enhancement techniques.
Error Detection Rate: This metric represents how accurately the system detects errors. A higher detection rate indicates better error response capability.
Error Recovery Rate: This metric measures the percentage of detected errors that are successfully corrected. A higher recovery rate suggests that the applied resilience enhancement techniques are more effective.

In addition to assessing error detection and recovery performance, this module evaluates the trade-off between resilience enhancement techniques and associated costs. In other words, it determines the extent to which reliability improves while also considering potential increases in power consumption and performance degradation.

Through this evaluation process, the present invention enables a quantitative assessment of the trade-off between reliability improvement and cost, allowing the ML-Based Explorator to automatically search for the optimal resilience enhancement technique combination in later stages.

Unlike traditional static resilience evaluation methods, the RESA Engine in the present invention continuously collects and analyzes error data in real time, dynamically assessing the effectiveness of resilience enhancement techniques. This allows the system to apply the best resilience enhancement techniques across various hardware and software environments, maximizing reliability while minimizing power consumption and performance degradation.

### Operation of the ML-Based Explorator

FIG. 6 illustrates the operation of the ML-Based Explorator according to one embodiment of the present invention. The ML-Based Explorator utilizes Machine Learning (ML) to explore optimal resilience enhancement technique combinations across different layers and analyze the trade-off between error improvement rates and costs. Conventional resilience enhancement techniques typically follow a static approach where a predefined protection mechanism is applied. However, such static methods are often unable to adapt to environmental changes and may lead to unnecessary performance degradation and increased power consumption. In contrast, the ML-Based Explorator in this invention leverages feedback-based learning techniques to automatically explore and apply the most effective resilience enhancement techniques, even in dynamically changing system environments.

The operation of the ML-Based Explorator consists of four key phases: initial sampling, cross-layer application, technique set evaluation, and ML optimizer-based optimization.

### Initial Sampling Process

The operation of the ML-Based Explorator begins with the initial sampling (310) phase, where it receives input from the RESA Engine, which provides an analysis of effective resilience enhancement techniques. In this phase, sampling techniques such as random sampling and grid sampling are used to select resilience enhancement technique combinations to be applied to at least one layer.
Random sampling randomly selects resilience enhancement techniques from a predefined set, establishing an initial search space. While this method may not yield optimal combinations initially, it offers the advantage of a broad exploration range.
Grid sampling systematically selects resilience enhancement techniques within a specified parameter range at fixed intervals, ensuring that patterns are followed to identify the best combinations.

Through this initial sampling process, the ML-Based Explorator defines a candidate set of various resilience enhancement technique combinations and initiates the search for the most effective configuration.

### Cross-Layer Application Phase

Once the resilience enhancement technique combinations have been selected through initial sampling, they proceed to the cross-layer application (320) phase, where they are applied to the actual system environment. During this phase, artificial errors are injected and detected through experimental validation.

In this step, soft errors are introduced to the system while specific resilience enhancement techniques are applied. The error injection method follows the Error Injection Module in the RESA Engine, injecting Single Event Upset (SEU) or Single Event Multiple Upset (SEMU) errors into the system under real-world conditions. The system's response to these errors is then evaluated.

Error data collected from this process is stored for subsequent analysis, allowing the system to evaluate the effectiveness of resilience enhancement techniques and identify the most optimal combination for improving error detection and recovery performance.

### Technique Set Evaluation Phase

Following data collection, the system enters the technique set evaluation (330) phase, where the error data collected from the RESA Engine is compared with baseline error data (obtained without resilience enhancement techniques). This phase quantitatively assesses the improvement in error resilience and evaluates the associated costs.

In this phase, several key performance metrics are used to analyze the effectiveness of resilience enhancement techniques:
Error Improvement Rate: Measures how effectively the resilience enhancement technique mitigates soft errors.
Cost Analysis: Evaluates potential increases in power consumption and performance degradation resulting from the applied resilience enhancement techniques.

Since enhancing system reliability often incurs trade-offs in performance and power consumption, this phase aims to find the optimal resilience enhancement technique that minimizes overhead while maximizing reliability. If a technique combination is deemed to provide high error mitigation efficiency at minimal cost, it is selected as the optimal resilience enhancement technique set.

### Optimization Process Using ML Optimizer

If a selected combination is not deemed optimal, the ML optimizer utilizes various machine learning-based optimization techniques, such as:
Reinforcement Learning (RL): Tries various resilience enhancement combinations and assigns rewards based on their effectiveness. The learning process initially selects random combinations but progressively refines the choices based on past results.
Bayesian Optimization: Predicts the most promising combinations based on previous experimental data, reducing the need for exhaustive searches.
Genetic Algorithm (GA): Generates new technique combinations through mutation and crossover, gradually evolving toward better solutions.
Neural Network-Based Optimization: Uses deep learning models to learn the impact of resilience enhancement techniques on reliability and cost, predicting optimal combinations.

The ML optimizer continuously iterates through the optimization cycle, refining the selection process by re-evaluating combinations through the cross-layer application (320) and technique set evaluation (330) phases. This iterative learning ensures that the best resilience enhancement technique set is dynamically identified and applied.

By incorporating these advanced machine learning techniques, the ML-Based Explorator minimizes computational costs while delivering high resilience enhancement efficiency, ensuring adaptability across different environments.

The RESA Engine in this invention quantitatively evaluates the effectiveness of each resilience enhancement technique through error detection and analysis, while the ML-Based Explorator leverages these evaluations to automatically find and apply the most optimal resilience enhancement techniques.

Unlike conventional static resilience enhancement methods, which rely on predefined protection mechanisms, the proposed system dynamically explores and optimizes resilience enhancement techniques based on real-time error data and system conditions.

In summary, the proposed invention provides a system that explores resilience enhancement techniques across multiple layers, utilizes error detection and analysis data, and applies machine learning to derive the optimal resilience enhancement combination. This approach maximizes reliability improvement while minimizing associated costs, making it an efficient and adaptive solution for resilience optimization in modern digital systems.

### Advantages and Effects of the Invention

The present invention overcomes the limitations of conventional resilience enhancement techniques, maximizing reliability improvements while minimizing performance degradation and power consumption. Traditional resilience enhancement methods primarily employ static protection mechanisms, which remain unchanged regardless of system environment variations. In contrast, the present invention quantitatively evaluates the effectiveness of resilience enhancement techniques through error detection and analysis and utilizes machine learning to explore and apply the optimal resilience enhancement technique combinations in real time. As a result, the system can automatically apply optimized resilience enhancement techniques across various application environments.

One of the key advantages of this invention is maximized reliability improvement. Traditional methods apply predefined protection mechanisms, making it difficult to adapt to environmental or system configuration changes. However, the RESA Engine in this invention detects and analyzes errors to quantitatively evaluate the effectiveness of each resilience enhancement technique, ensuring that the most effective techniques are applied, leading to substantial reliability improvements.

Additionally, the invention enhances error mitigation efficiency while reducing costs. Traditional methods often apply unnecessary protection mechanisms, leading to excessive costs. In contrast, the ML-Based Explorator searches for cost-effective resilience enhancement techniques, evaluates their impact on reliability improvement, and selects the optimal combination. This ensures maximum error mitigation at minimal cost.

The invention also provides real-time optimization and adaptability. The system dynamically adjusts resilience enhancement techniques based on changing system conditions using machine learning-based exploration. Unlike conventional static resilience enhancement methods, this invention continuously optimizes reliability through adaptive learning, ensuring applicability across new applications and chip environments.

As a result, this invention offers a flexible resilience enhancement design system that can be applied in various environments, maximizing reliability improvement while minimizing costs such as performance degradation and power consumption.

### Alternative Implementations

The present invention can be implemented in various ways and is not limited to specific hardware or software platforms. Fundamentally, the invention is designed to process RTL (Register Transfer Level) data as input and perform resilience enhancement processes. However, it can be adapted to different forms based on system requirements or specific application environments.

The first alternative implementation is a hardware-accelerated approach. Currently, the invention performs software-based analysis and exploration, but it can be accelerated using specialized hardware modules such as FPGAs and ASICs to enhance resilience enhancement technique exploration and application processes. For instance, if the ML-Based Explorator is implemented using a hardware accelerator, it can significantly improve exploration speed and enable more efficient real-time analysis.

The second alternative implementation is a cloud-based optimization model. Traditionally, resilience enhancement technique exploration has been performed on local systems, but it can also be executed in cloud environments to facilitate large-scale data analysis and learning. By leveraging cloud-based machine learning models, the system can utilize a more extensive dataset to identify the optimal resilience enhancement techniques and develop reusable optimization models for various environments.

The third variation is applying the invention to distributed systems and network environments. The present invention primarily focuses on optimizing resilience enhancement techniques at the individual chip or system level. However, it can be expanded to distributed systems, allowing data centers to detect and analyze errors and optimize resilience enhancement techniques across interconnected servers.

Lastly, an alternative implementation using various machine learning algorithms is also feasible. Currently, the invention employs Reinforcement Learning, Bayesian Optimization, and Genetic Algorithms for resilience enhancement technique exploration. However, emerging machine learning techniques such as transformer-based optimization models and neural network-based exploration techniques can also be incorporated in future implementations to enhance optimization efficiency further.

Given these alternative implementations and variations, the present invention is not restricted to specific hardware or software environments and can be expanded and optimized in various ways, making it a highly adaptable resilience enhancement system.

### Conclusion and Future Prospects

The present invention provides a system that quantitatively evaluates resilience enhancement techniques through error detection and analysis and leverages machine learning to explore and apply the optimal resilience enhancement technique combinations. While conventional resilience enhancement approaches rely on static protection mechanisms, this invention enables real-time optimization and adaptation to environmental changes. As a result, the system maximizes reliability while minimizing costs such as performance degradation and power consumption.

In terms of future developments, one significant area is the further advancement of high-speed exploration and optimization techniques. Currently, the ML-Based Explorator utilizes multiple machine learning techniques to explore resilience enhancement techniques. However, developing faster and more efficient optimization techniques could further improve the exploration speed.

Another key development direction is applying the invention to large-scale distributed systems and cloud environments. While the current invention is designed to optimize resilience enhancement techniques at the individual system level, it can be extended to cloud-based execution, enabling resilience enhancement optimization for data centers and large-scale network environments.

Finally, building a fully automated resilience enhancement framework is another important possibility. Currently, resilience enhancement techniques are applied based on specific system requirements through analysis and optimization. However, in the future, a fully automated resilience enhancement framework could be developed, allowing optimal resilience enhancement techniques to be automatically applied across diverse hardware and software environments.

In conclusion, the present invention overcomes the limitations of conventional resilience enhancement methods and provides an innovative resilience enhancement system that performs real-time optimization using machine learning. This allows high-reliability digital and embedded systems to automatically explore and apply optimal resilience enhancement techniques. Furthermore, with advancements in optimization techniques and automation frameworks, the invention is expected to be widely applicable across even broader fields in the future.

1. A resilience enhancement design system, comprising:
A RESA (Resilience Evaluation through Sensing and Analysis) Engine configured to inject artificial errors and detect and analyze errors in the configured system;
An ML-Based Explorator configured to explore resilience enhancement techniques at each layer and apply an optimal combination.

2. The resilience enhancement design system of claim 1, wherein the RESA Engine:
Injects artificial errors into one or more processing units; and
Analyzes detected error data to evaluate resilience enhancement techniques.

3. The RESA Engine of claim 2, wherein error injection:
Operates based on the probability of soft errors occurring in real environments for one or more processing units.

4. The RESA Engine of claim 2, wherein error detection and analysis:
Detects soft errors occurring at each layer, analyzes error types, and collects error data.

5. The RESA Engine of claim 2, wherein the evaluation of resilience enhancement techniques:
Applies resilience enhancement techniques based on collected error data and evaluates error detection rates and error recovery rates.

6. The resilience enhancement design system of claim 1, wherein the ML-Based Explorator further comprises:
Applying resilience enhancement techniques to at least one layer;
Evaluating the error improvement rate for each layer and its associated costs; and
Utilizing machine learning-based exploration to optimize the trade-off between resilience enhancement and costs.

7. The resilience enhancement design system of claim 6, wherein the ML-Based Explorator:
Independently evaluates error improvement rates, including error detection rates and error recovery rates, for resilience enhancement techniques applied at each layer.

8. The resilience enhancement design system of claim 6, wherein the ML-Based Explorator:
Evaluates costs associated with the application of resilience enhancement techniques, including increased power consumption and performance degradation.

9. The resilience enhancement design system of claim 6, wherein machine learning-based exploration:
Utilizes feedback-driven machine learning optimization techniques; and
Analyzes the trade-off between error improvement rates and costs, progressively learning and automatically determining an optimal resilience enhancement technique combination.

10. A method for optimizing resilience enhancement techniques using machine learning, comprising:
Receiving resilience enhancement techniques and selecting an initial combination to be applied to at least one layer;
Performing a cross-layer application process, wherein the selected resilience enhancement techniques are applied to the system, artificial errors are injected and detected, and error data is collected;
Evaluating the trade-off between error improvement rates and related costs by comparing collected error data with baseline error data without resilience enhancement techniques; and
Utilizing feedback-driven machine learning optimization techniques to iteratively refine and determine an optimal combination of resilience enhancement techniques.

11. The method of claim 10, wherein the step of selecting the initial resilience enhancement technique combination:
Applies sampling techniques, including but not limited to, random sampling and grid sampling, to explore various resilience enhancement technique combinations across different layers.

12. The method of claim 10, wherein the step of evaluating resilience enhancement techniques:
Compares collected error data with baseline error data from the RESA Engine to assess error detection rates and error recovery rates associated with the resilience enhancement techniques.

13. The method of claim 10, wherein the step of feedback-driven machine learning optimization:
Employs machine learning optimization techniques without being limited to Reinforcement Learning and Bayesian Optimization; and
Continuously enhances the combination of resilience enhancement techniques by analyzing the trade-off between error improvement rates and costs.
